(19) United States
(12) Patent Application Publication
(10) Pub. No.: US 2016/0016386 A1
(43) Pub. Date: Jan. 21, 2016

(54) Reflective Insulation

(71) Applicant: INTERNATIONAL INSULATION PRODUCTS LLC, Smyrna, GA (US)

(72) Inventors: Dermot Joseph Ennis, Spring Grove, PA (US); Terry Ferrero, Roswell, GA (US)

(73) Assignee: International Insulation Products LLC, Smyma, GA (US)

(21) Appl. No.: 14/772,083

(22) PCT Filed: Feb. 27, 2014
(86) PCT No.: PCT/US2014/018824

§ 371 Date: Sep. 2, 2015

Related U.S. Application Data
(60) Provisional application No. 61/772,013, filed on Mar. 4, 2013.

(51) Int. Cl. B32B 15/14; B32B 15/20; B32B 37/12; B32B 27/36; B32B 27/32; B32B 7/12; B32B 5/02; B32B 27/12

(52) U.S. Cl. CPC B32B 15/14; B32B 5/022; B32B 15/20; B32B 27/12; B32B 27/36; B32B 27/32; B32B 7/12; B32B 37/1207; B32B 2262/101; B32B 2307/304; B32B 2307/31; B32B 2307/7242; B32B 2307/416; B32B 2307/206

(57) ABSTRACT

A reflective insulation includes a first layer and a second layer, the first layer being a reflective layer and the second layer being an insulation layer. An activated heat seal film between and in contact with the first and second layers adheres the first and second layers together. The Zupon et al. reflective insulation includes a reflective layer A (which reflective layer may be formed from aluminum), an insulation layer B formed of fiberglass, and a vapor barrier layer C (which vapor barrier layer may be formed from plastic or a reflective material such as the aluminum).

### FIELD OF THE DISCLOSURE

This disclosure relates to reflective insulation and related methods of making reflective insulation.

### BACKGROUND OF THE DISCLOSURE

Zupon et al. U.S. Pat. No. 6,797,356 discloses a reflective insulation. A schematic representation of the manufacture of the Zupon et al. reflective insulation is shown in FIG. 4.

The Zupon et al. reflective insulation includes a reflective layer A (which reflective layer may be formed from aluminum), an insulation layer B formed of fiberglass, and a vapor barrier layer C (which vapor barrier layer may be formed from plastic or a reflective material such as the aluminum).

A first side of the fiberglass layer B is bonded to the reflective layer A by a deposit of hot melt glue D. A second side of the fiberglass layer is bonded to the vapor barrier layer by a second deposit of hot melt glue E. During manufacture, the hot melt glue is applied in liquid form directly to the opposite sides of the fiberglass layer, and the reflective layer and vapor barrier layers are then placed onto the sides of the fiberglass over the liquid hot melt glue. The laminated product passes between rollers that compress the laminations for intimate contact of the wet, liquid glue and the lamination layers.

Although the Zupon et al. insulation generally works well in suitable applications, it has been found that the wet glue adhesive does not always provide adhesion over the entire area of lamination. It is theorized that gaps or inconsistencies in the application of the hot melt glue onto the fiberglass results in gaps or unadhered areas between the fiberglass and the reflective layer or vapor barrier of the finished product. Because the reflective and vapor barrier layers must be placed over the fiberglass immediately after the hot melt glue is applied, it can be difficult to inspect for or otherwise assure uniform, satisfactory coverage and adhesion of the glue with the laminations.

### SUMMARY OF THE DISCLOSURE

Disclosed is a reflective insulation that has a laminated structure that includes a reflective layer, an insulation layer such as a fiberglass layer, and a vapor layer or alternatively a second reflective layer. The vapor layer may also be a reflective layer. The layers adhere to each other using a heat seal film that is preferably activated using flame lamination.

A heat seal film is typically a thermoplastic film that is applied onto a substrate surface and later activated by heat to become adhesive and thereby form an adhesive film that can adhere to another surface. In possible embodiments, heat can be applied by flame lamination. Flame lamination is a process wherein a material such as a heat seal film is passed over a flame to create a thin layer of melted or otherwise tacky material that acts as an adhesive material. The adhesive material is then brought into contact with the material forming the adjacent layer of a laminate under pressure to develop a bond between the two surfaces.

The disclosed reflective insulation has a number of advantages. Because a heat seal film is being used, the film can be applied to a side of a material forming one of the laminations well before the reflective insulation is made. Thus qualify control of the resulting adhesion layer is better controlled to assure satisfactory adhesion between laminations over the entire product.

In addition, flame lamination of a heat seal film results in an improved adhesion layer with less likelihood of later separation lamination layers and with greater mechanical strength as compared to the use of hot melt glue. Thus the reliability of the reflective insulation is improved.

Furthermore, by using a heat film that is attached to the outer reflective lamination layers prior to manufacture, the insulation layer can be formed from organic insulation instead of fiberglass.

Other objects and features of the disclosure will become apparent as the description proceeds, especially when taken in conjunction with the accompanying drawing sheets.

### BRIEF DESCRIPTION OF THE DRAWINGS

FIG. 1 is a section view of a reflective insulation;

FIG. 2 is a schematic representation of an apparatus for producing the reflective insulation shown in FIG. 1; and

FIG. 4 schematically illustrates manufacture of a prior art reflective insulation.

### DETAILED DESCRIPTION

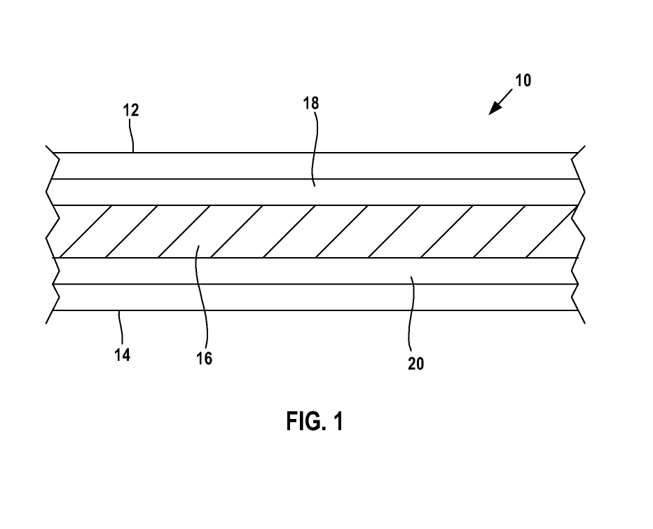

FIG. 1 illustrates a reflective insulation 10 in accordance with the present disclosure. FIG. 1 illustrates the reflective insulation 10 being formed from a first reflective layer 12 made of aluminum film on one side of the insulation 10, a second reflective layer 14 made of aluminum film on the other side of the insulation 10, and an insulation layer 16 made of fiberglass or an organic insulation between the reflective layers 12, 14. An activated heat seal film 18 is shown separate from and between the first reflective layer 12 and the insulation layer 16, and an activated heat seal film 20 is shown separate from and between the second reflective layer 14 and the insulation layer 16. The activated heat seal film layers 18, 20 contacts the reflective layers 12, 14 respectively and the respective opposite sides of the insulation layer 16, adhering the reflective layers 12, 14 to the insulation layer 16. In the illustrated embodiment the heat seal films are activated by flame lamination as will be described in further detail below.

In possible embodiments of the disclosed reflective insulation, aluminum film that will form part of the reflection layer 12 or reflector layer 14 defines or forms a substrate that is provided with the heat seal film to form an integral material prior forming part of the reflective insulation 10. The heat seal film is preapplied as a backing to one side of the aluminum film substrate. Such an integral heat seal film/aluminum film material is commercially available from the Johns-Manville Corporation, of Denver, Colo. USA. The heat seal film adhering to the aluminum film substrate is then activated when manufacturing the reflective insulation 10 to adhere the aluminum film to the insulation.

If desired in alternative embodiments, a reflective layer 12 and/or a reflective layer 14 can be formed as a conventional perforated layer having perforations (not shown). The perforations enable air to escape from between the reflective layer and the insulation layer during manufacture of the reflective insulation.

In other possible embodiments, the reflective layer 14 can be formed from a polyester or polyethylene material. The polyester or polyethylene in possible embodiments may also be flame laminated to the insulation during manufacture of the reflective insulation 10.

In yet other possible embodiments, the reflective layer 14 can be replaced with a vapor barrier or can itself form a vapor barrier. The vapor barrier can be formed from a polyester or polyethylene material. The polyester or polyethylene in possible embodiments may be adhered to the insulation by an activated heat seal film or, in other possible embodiments, the polyester or polyethylene may itself be flame laminated directly to the insulation during manufacture of the reflective insulation 10.

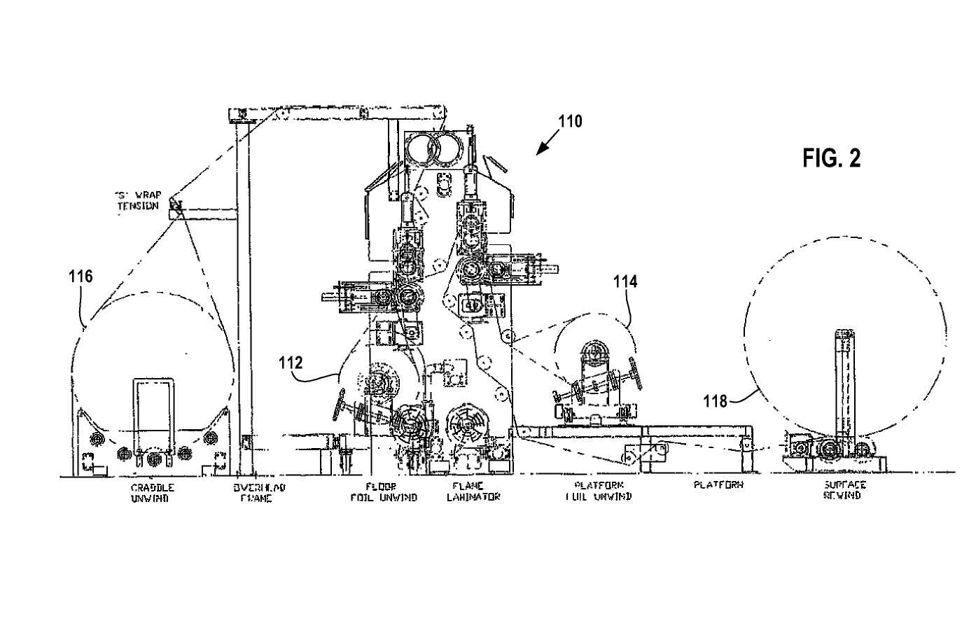

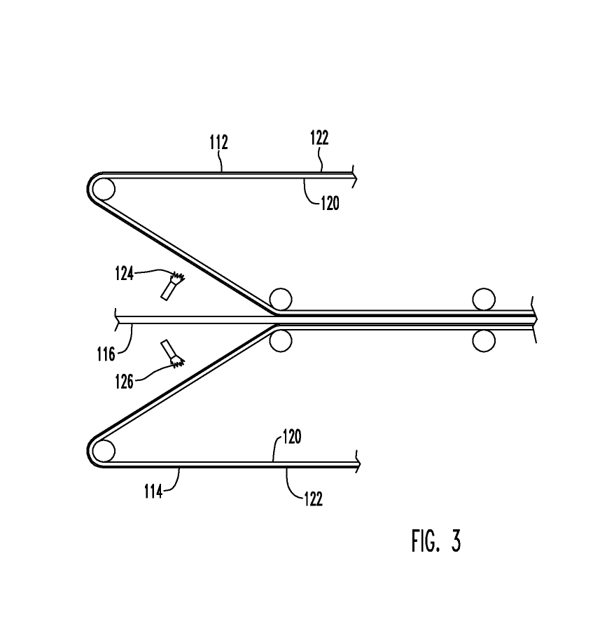

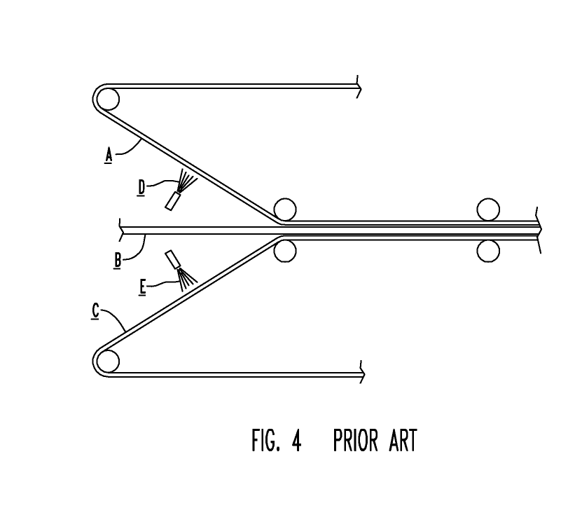

FIG. 2 illustrates a flame laminator machine 110 used for the manufacture of the reflective insulation 10 shown in FIG. 1. A pair of rolls 112, 114 of aluminum film or foil having a heat seal film backing on one side of the foil as described above is unrolled and fed into the flame laminator machine. A roll 116 of fiberglass matt is unrolled and fed into the flame laminator machine. In the illustrated embodiment the fiberglass layer is one-quarter inch thick and is otherwise the same fiberglass matt disclosed in the Zupon, et al. patent. The aluminum film may be 0.0003 inches thick.

The flame laminator machine heats the heat seal film on the aluminum films until the film is tacky or otherwise in condition for application as an adhesive. After being heated, the films are pressed against the opposite sides of the fiberglass to adhere the heat seal films and thereby the aluminum film against the fiberglass. The resulting laminated reflective insulation 118 is rolled onto a roller for later processing.

FIG. 3 illustrates flame laminating the materials from the rolls 112, 114 to the insulation from the roll 116 to form the reflective insulation 118 (which is identical to the reflective insulation 10). The materials from the rolls 112, 114 each includes an aluminum film 120 having an integral heat seal film 122 on one side of the aluminum film. The heat seal film 112 is passed over an open flame 124 or open flame 126, thereby creating a thin layer of melted adhesive prior to the adhesive being adhered to the insulation 116.

While this disclosure includes one or more illustrative embodiments described in detail, it is understood that the one or more embodiments are each capable of modification and that the scope of this disclosure is not limited to the precise details set forth herein but include such modifications that would be obvious to a person of ordinary skill in the relevant art, as well as such changes and alterations that fall within the purview of the following claims.

1. A reflective insulation comprising:
a first layer and a second layer;
the first layer being a reflective layer which reflects radiant heat;
the second layer being an insulation layer and having opposite first and second sides;
characterized by
a first activated heat seal film in contact with the first layer and the first side of the second layer, the first activated heat seal film adhering the first layer to the first side of the second layer.

2. The reflective insulation of claim 1 wherein the first activated heat seal film is activated by exposure to flame.

3. The reflective insulation of claim 1 comprising a third layer, the third layer being a reflective layer which reflects radiant heat;
a second activated heat seal in contact with the third layer and the second side of the second layer, the second activated heat seal film adhering the third layer to the second side of the second layer.

4. The reflective insulation of claim 1 comprising a third layer, the third layer being a vapor barrier;
a second activated heat seal film in contact with the third layer and the second side of the second layer, the second activated heat seal film adhering the third layer to the second side of the second layer.

5. The reflective insulation of claim 4 wherein the third layer is also a reflective layer that reflects radiant heat.

6. The reflective insulation of claim 1 wherein the first heat seal film adheres to the first layer prior to activation of the first heat seal film.

7. The reflective insulation of claim 1 wherein one or both of the first and third layers comprises aluminum, polyester, or polyethylene.

8. The reflective insulation of claim 1 wherein the second layer comprises organic insulation.

9. The reflective insulation of claim 1 comprising a third layer, the third layer being a vapor barrier and comprising polyester or polyethylene;
the polyester or polyethylene being flame laminated to the second side of the second layer.

10. A method for manufacturing a reflective insulation comprising:
(a) providing a first layer and a second layer, the first layer being a reflective layer that reflects radiant heat and the second layer being an insulation layer;
characterized by
(b) activating a first heat set film;
(c) placing the activated first heat set film between a first side of the first layer and a first side of the second layer and in contact with the first sides of both the first layer and the second layer whereby the activated first heat set film adheres the first layer to the second layer.

11. The method of claim 10 wherein step (b) comprises exposing the first heat set film to a flame.

12. The method of claim 10 comprising the steps of:
(d) providing a third layer;
(e) activating a second heat set film;
(f) placing the activated second heat set film between a first side of the third layer and a second side of the second layer and in contact with the first side of the third layer and the second side of the second layer whereby the activated second heat set film adheres the third layer to the second layer.

13. The method of claim 12 wherein the second heat set film adheres to the third layer prior to activation of the second heat set film.

14. The method of claim 12 wherein the third layer functions as at least one of a reflective layer and a vapor barrier.

15. The method of claim 10 comprising the steps of:
(d) unrolling the first layer from a first roll;
(e) unrolling the second layer from a second roll;
(f) passing the first heat set film through a flame to thereby activate the first heat set film; and
(g) adhering the unrolled first layer and the unrolled second layer together with the activated first heat set film.

16. The method of claim 15 comprising the steps of:
(h) unrolling a third layer from a third roll;
(i) passing a second heat set film through a flame to thereby activate the second heat set film; and
(j) adhering the unrolled second layer and the unrolled third layer together with the activated second heat set film.

17. The method of claim 16 wherein the second heat set film adheres to the third layer prior to activation of the second heat set film.

18. The method of claim 10 wherein the second layer comprises organic insulation.

19. The method of claim 10 wherein the first heat set film adheres to the first layer prior to activation of the first heat set film.

20. The method of claim 10 comprising the steps of:
(d) providing a third layer, the third layer comprising polyurethane or polyester; and
(e) flame laminating a side of the polyurethane or polyester to a second side of the second layer thereby adhering the third layer to the second layer.
